(19) United States
(12) Patent Application Publication
(10) Pub. No.: US 2002/0023226 A1
(43) Pub. Date: Feb. 21, 2002

(54) Falsification preventing apparatus, falsification preventing method and recording medium therefor

(75) Inventor: Tetsuo Takagi, Osaka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: KABUSHIKI KAISHA Network Doc, Tokyo (JP)

(21) Appl. No.: 09/753,622

(22) Filed: Jan. 4, 2001

(30) Foreign Application Priority Data
Aug. 21, 2000 (JP) 250006/2000

(51) Int. Cl. G06F 12/16

(52) U.S. Cl. 713/201

(57) ABSTRACT

A monitoring section detects a write instruction to an open directory of a recording section in a control section from a write and read control section. When a falsification detection signal is inputted from the monitoring section to a control section, the control section controls a copy control section to read and copy information stored in backup directories to the open directory. This can prevent the open directory from being falsified. Since falsification is detected by detecting the write instruction, a high storage recording device and a high CPU capability are not required to detect the falsification.

### BACKGROUND OF THE INVENTION

1. Field of the Invention

The present invention relates to a falsification preventing apparatus, a falsification preventing method and a recording medium therefor suited for a Web server on the Internet.

2. Related Art Statement

The Internet becomes increasingly popular in recent years. Access to a Web server (Web access), in particular, is widespread since it facilitates the opening and acquisition of various information on the Internet. Places where information is opened on the Internet WWW (World Wide Web) are normally referred to as “Web site”. By storing a Web site on the Web server, information is opened to the public.

A user designates a URL which is the address of a Web site using a Web browser software running on a personal computer connected on the Internet, thereby making it possible to access the Web server and to download and display desired information (pages).

Recently, however, hackers, crackers and the like unlawfully accessing Web sites on Web servers and falsifying them are on the increase. The hackers unlawfully access the Web servers by taking advantage of, for example, the security holes of the Web servers and falsify information on the Web sites.

To prevent such unlawful access from hackers, there is proposed establishing firewalls on information opening sides. However, to set security level high, it is also required to establish a high-level firewall and security management is complex. In addition, once a hacker overpasses the firewall and unlawfully access the Web site, it is impossible to prevent the falsification and the like of the Web severs.

Considering this, there is proposed a system for detecting the falsification of a file by checksum calculation or the like and notifying an administrator of the detection result. According to this system, a value obtained by extracting the character of an entire file and converting the extracted character into a small bit string is used as a checksum. By monitoring the checksum value of the original file, unlawful falsification is detected.

However, the system for monitoring the checksum of a file and detecting unlawful falsification disadvantageously requires an extremely high CPU capability and an extremely high recording capacity so as to perform arithmetic operation and to record the checksum for such monitoring.

### OBJECT AND SUMMARY OF THE INVENTION

It is an object of the present invention to provide a falsification preventing apparatus, a falsification preventing method and a recording medium therefor capable of preventing falsification by allowing an original file to be automatically restored right after falsification without requiring a high CPU capability and a high recording capacity.

A falsification preventing apparatus according to the present invention is characterized by comprising: an open recording region storing a page opened on the Internet; a backup recording region storing backup information on information stored in the open recording region; monitoring means for detecting a write instruction with respect to the open recording region; and copy means for copying the backup information stored in the backup recording region to the open recording region when the monitoring means detects the write instruction with respect to the open recording region.

Also, a falsification preventing method according to the present invention is characterized by comprising the steps of: detecting a write instruction with respect to an open recording region storing a page opened on the Internet; and reading backup information on information stored in the open recording region from a backup recording region storing the backup information, and copying the backup information to the open recording region when the write instruction with respect to the open recording region is detected.

Further, a computer readable recording medium according to the present invention is characterized by recording a program for making a computer execute: a processing for detecting a write instruction with respect to an open recording region storing a page opened on the Internet; and a processing for reading backup information on information stored in the open recording region from a backup recording region storing the backup information and copying the backup information to the open recording region when the write instruction with respect to the open recording region is detected.

The other features and advantages of the present invention will become readily obvious by the description which follows.

### BRIEF DESCRIPTION OF THE DRAWINGS

FIG. 1 is a block diagram showing one embodiment of a falsification preventing apparatus according to the present invention;

FIG. 2 is an explanatory view for a falsification preventing system; and

FIG. 3 is a flow chart showing write control for preventing falsification.

### DETAILED DESCRIPTION OF THE PREFERRED EMBODIMENTS

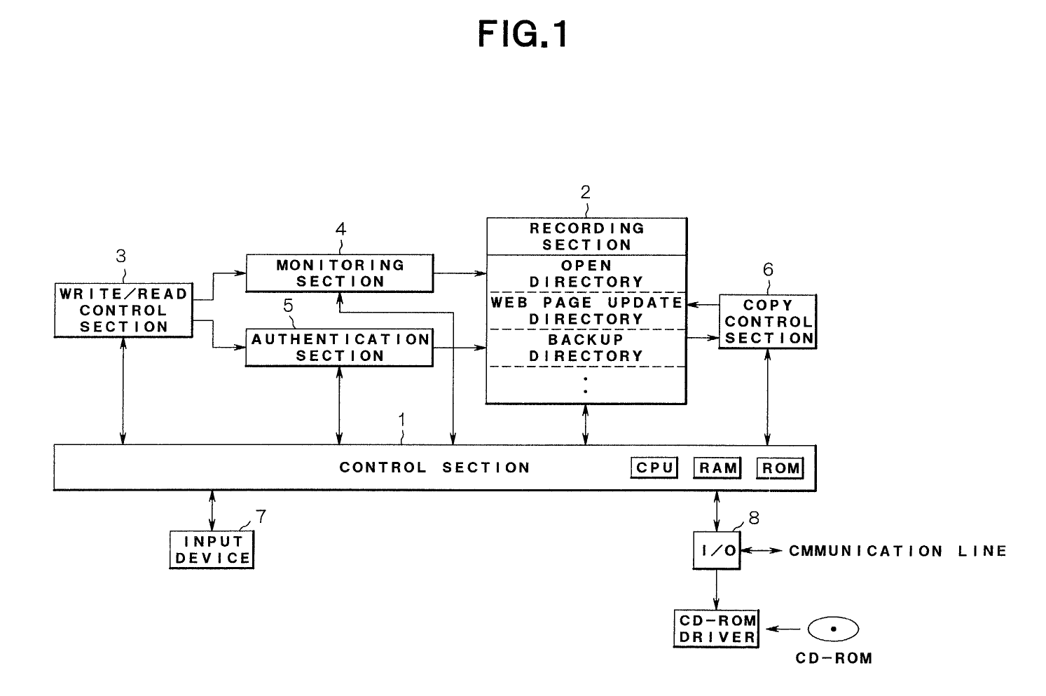

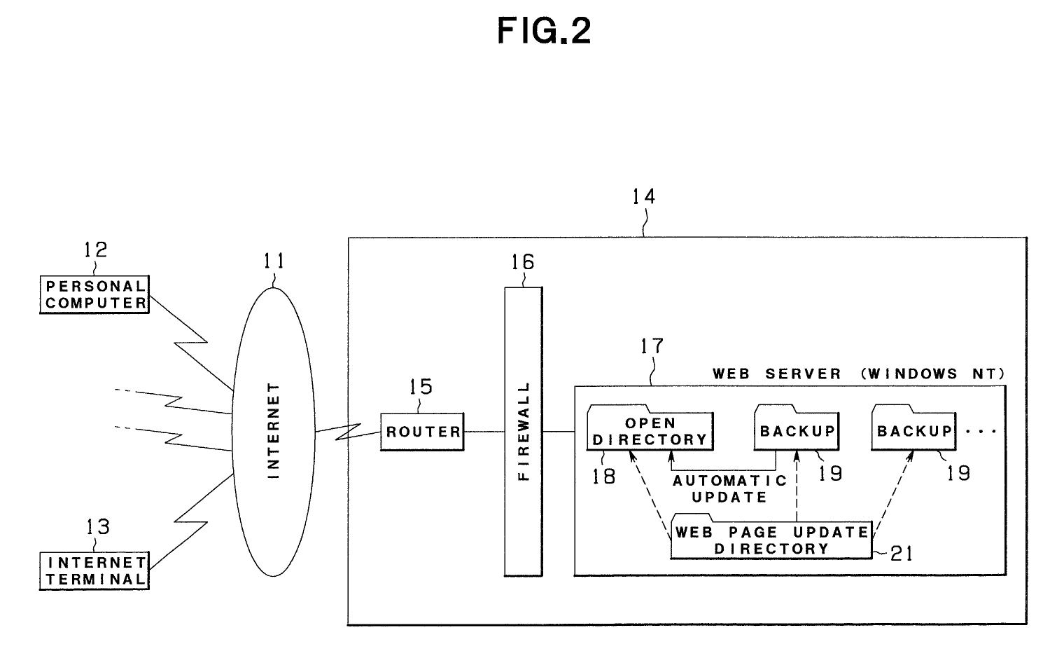

The embodiment of the present invention will be described hereinafter with reference to the accompanying drawings. FIG. 1 is a block diagram showing one embodiment of a falsification preventing apparatus according to the present invention. FIG. 2 is an explanatory view for a falsification preventing system.

In FIG. 2, a plurality of personal computers 12 and various types of Internet terminals 13 are connected to the Internet 11. An information provider's network 14 is connected to the Internet 11 through a router 15. A firewall 16 is provided between the router 15 and a Web server 17. The firewall 16 is designed to be capable of preventing unlawful access to the Web server 17 through the Internet 11.

For instance, the firewall 16 makes a request such as an HTTP protocol request to the Web server 17 and outputs a response to the request to the Internet 11. The firewall 16 is capable of prohibiting access to other unauthorized protocols, servers, terminals and the like. The firewall 16 allows an access restraint for every application.

The Web server 17 adopts Windows NT (trademark), for example, as an operating system or OS and is capable of executing a processing in response to Web access. Namely, in response to a request such as an HTTP protocol request, the Web server 17 outputs a designated file as a response to the request.

In this embodiment, the Web server 17 has an open directory 18 for storing a Web site and has a plurality of backup directories 19 for backing up the open directory 18. The Web server 17 synchronizes the open directory 18 with the backup directories 19 at predetermined time intervals. If the open directory 18 is falsified, the open directory 18 can be automatically updated using the contents of the backup directories 19.

The Web server 17 also has a Web page update directory 21 and is capable of updating the open directory 18 and the backup directories 19 using the content of the Web page update directory 21. When the information provider rewriting his or her Web site, it is possible to update and open the Web site by rewriting the Web page update directory 21.

FIG. 1 is a block diagram showing the concrete constitution of a falsification preventing apparatus incorporated into the computer and constituting the Web server 17 in shown in FIG. 2.

An I/O (input/output section) 8 is connected to the firewall 16 shown in FIG. 2. An input device 7 is constituted out of a keyboard or the like, outputs a signal based on a user's operation to a control section 1 and gives various instructions to the control section 1.

The control section 1 is realized by an OS such as Windows NT, a server software or the like, and is designed to operate based on the signal from the input device 7 and to control respective constituent elements of the system. That is to say, the control section 1 has a CPU, an RAM, an ROM and the like as hardware, executes a program stored in the ROM or a program read from an external storage device such as a hard disk and executes various processings. It is noted that the control section 1 can acquire various types of data including programs from various devices such as a CD-ROM driver through the I/O 8.

A recording section 2 is constituted out of a hard disk or the like and has a region storing the open directory, the backup directories, the Web page update directory and the like shown in FIG. 2. A write and read control section 3 controls a write and read processing with respect to the recording section 2. The recording section 2 is controlled by the write and read control section 3, records information from the control section 1, and reads and provides the recorded information to the control section 1.

When a Web site request is inputted from the I/O 8, the control section 1 controls the write and read control section 3 to thereby read the Web site recorded on the open directory of the recording section 2, output the Web site to the Internet 11 through the I/O 8 as a response to the request.

In this embodiment, a monitoring section 4 is provided to detect whether or not the write and read control section 3 has given a write instruction to the open directory. The monitoring section 4 detects that a write operation is conducted to the open directory and outputs a falsification detection signal to the control section 1. In this embodiment, there is also provided a copy control section 6 for copying the contents of the backup directories to the open directory. The copy control section 6 is controlled by the control section 1, gives an instruction to the write and read control section 3 to copy data.

When the falsification detection signal is inputted from the monitoring section 4, the control section 1 controls the copy control section 6 to thereby copy the contents of the backup directories to the open directory. In addition, when the Web page update directory is updated, the copy control section 6 is controlled by the control section 1 to thereby copy the content of the Web page update directory to the backup directories and the open directory.

While the copy control section 6 conducts a copying operation, the monitoring of the monitoring section 4 is invalidated.

When the falsification detection signal is inputted into the control section 1, the control section 1 notifies an administrator's computer, which is not shown, on the network 14 that falsification occurred through the I/O 8 and allows a display section, which is not shown, to display that the falsification occurred.

An authentication section 5 is controlled by the write and read control section 3 to request that a user be authenticated when a write operation is conducted to the Web page update directory and the backup directories in the recording section 2. When the authentication section 5 request the user's authentication, the control section 1 allows the display section or the like to display that the user's authentication is requested and allows a user to input a user's ID, a user's password or the like through the I/O 8 or by means of the input device 7. The authentication section 5 admits a write operation to the recording section 2 only when the user is authenticated.

Next, the operation of the embodiment constituted as stated above will be described.

It is assumed that a user, which can utilizes the personal computer 12 connected to the Internet, accesses an open Web server and acquires Web site information. The user starts a browser software on the personal computer 12 and inputs the URL of a Web site. A request from the personal computer 12 is transmitted to the information provider's network 14 through the Internet 11. The router 15 supplies the request transmitted through the Internet 11 to the Web server 17 through the firewall 16. This request is transmitted to the control section 1 through the I/O 8.

The control section 1 controls the write and read control section 3 in response to the request to thereby read Web site information stored in the open directory of the recording section 2 and output the Web site information as a response to the request from the I/O 8. This response is outputted onto the Internet 11 through the firewall 16 and the router 15, and fetched by the personal computer 12. The browser software started on the personal computer 12 displays the Web site based on the received response. Thus, the user on the Internet 111 can look at the Web site provided by the information provider on the browser software.

Here, it is assumed that a user on the Internet 11 unlawfully accesses the firewall 16 by some means and falsifies a Web site in the Web server 17. A write instruction given by the hacker is supplied to the write and read control section 3 by the control section 1. The write and read control section 3 writes data to the open directory of the recording section 2.

On the other hand, the monitoring section 4 detects the write instruction of the write and read control section 3 and outputs a falsification detection signal to the control section 1. If so, the control section 1 controls the copy control section 6 to copy the contents of the backup directories to the open directory. The monitoring section 4 monitors falsification at relatively short intervals, whereby it is possible to restore the open directory using the backup directories in quite a short time. For example, the copy control section 6 can start copying the contents of the backup directories in several milliseconds after the falsification starts.

In this case, therefore, original data is restored almost simultaneously with the falsification by the hacker and the Web site which is not falsified is displayed on the personal computers of other ordinary users. Alternatively, data may be restored to the original data in a predetermined time after it is detected that the hacker falsified the Web site.

The monitoring section 4 monitors the presence/absence of falsification by detecting the write instruction with respect to the open directory. The monitoring section 4 does not analyze the open directly, and does not require a mass storage recording section and a high CPU capability for the detection of falsification.

The monitoring section 4, for example, can be realized by using the function of Windows NT and the control section 1 is capable of easily, promptly monitoring falsification and restoring original data by generating an interruption instruction by the falsification detection signal and conducting copy control.

Next, it is assumed that the information provider oneself updates the open directory. In this case, the information provider instructs the update of the open directory by, for example, the input device 7. The control section 1 outputs an update instruction to the write and read control section 3 to thereby write data to the Web page update directory. When writing the data to the Web page update directory, the authentication section 5 request user's authentication. The control section 1 controls the display section to display that the user is to be authenticated. The user inputs the ID and password or the like for authenticating a user by the input device 7. Only when the ID and password inputted by the user are coincident with information registered in advance, the authentication section 5 admits data to be written to the Web page update directory. By doing so, it is possible to prevent a hacker from writing data to the Web page update directory. Likewise, it is possible to prevent the hacker from writing data to the backup directories.

When the user is authenticated, the write and read control section 3 updates the Web page update directory based on the user's operation. The copy control section 6 synchronizes the Web page update directory, the backup directories and the open directory with one another. If the Web page update directory is updated, the copy control section 6 copies the content of the Web page update directory to the backup directories and the open directory. In this way, the open directory is updated.

As can be seen from the above, in this embodiment, falsification is detected by detecting that data is written to the open directory, and the contents of the backup directories are copied to the open directory in a short time after the falsification is detected, whereby the open directory is automatically restored from the falsification. By doing so, it is possible to prevent falsification by allowing automatically restoring a file to an original file right after falsification without requiring a mass storage recording section and a CPU having high capability.

When the information provider updates the open directory, the automatic correction function by means of the detection of falsification and copy operation may be temporarily stopped. In that case, the open directory, the backup directories or the like can be directly updated.

The recording section 2 can be constituted out of one hard disk but out of a plurality of hard disks or a plurality of types of recording mediums. Needless to say, the open directory, the backup directories and the Web page update directory recorded on other recording mediums may be synchronized with one another and the contents of the Web page update directory, the backup directories and the open directory can be copied among these directories through an electrical communication line.

As already stated above, the monitoring section 4 can be realized by using the function of Windows NT. Likewise, the authentication section 5 can be, quite obviously, realized by a software. Besides, the copy control section 6 can be realized by an ordinary operating system or OS. That is, the system for preventing falsification by controlling the write of data to the recording section 2 in this embodiment is normally carried out by a software (program).

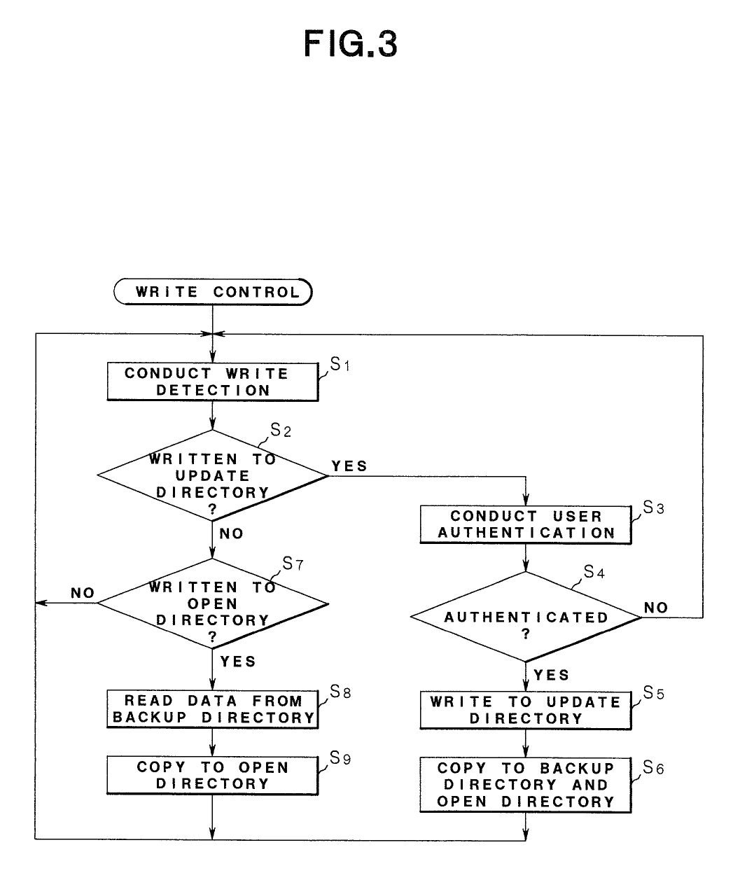

A falsification preventing method will be further described with reference to a flow chart shown in FIG. 3.

Write detection in a step S1 of FIG. 3 is conducted by the monitoring section 4 shown in FIG. 1. In a step S2, the control section 1 judges whether or not data is written to the update directory. If data is written to the update directory, the control section 1 conducts a processing for authenticating a user in a step S3. Only when the control section 1 detects that the user is a regular user by the authentication of the user, data is written to the update directory in a step S5. The content of the updated update directory is copied to the backup directories and the open directory in a step S6.

If it is judged in the step S2 that data is not written to the update directory, the control section 1 judges whether or not data is written to the open directory in a step S7. If the data is written to the open directory, the control section 1 reads data from the backup directories in a step S8, and updates the open directory using the read data. As a result, the content of the open directory is restored to that of the original Web site which is not falsified, right after the open directory is falsified.

As can be understood from the above, it is possible to prevent falsification by a simple software processing.

According to the present invention, it is obvious that different embodiments can be constituted based on the present invention without departing from the sprit and scope of the invention. The present invention should not be limited to specific embodiments except that the invention is limited by claims which follows.

What is claimed is:

1. A falsification preventing apparatus comprising:
an open recording region storing a page opened on the Internet;
a backup recording region storing backup information on information stored in said open recording region;
monitoring means for detecting a write instruction with respect to said open recording region; and
copy means for copying the backup information stored in said backup recording region to said open recording region when said monitoring means detects the write instruction with respect to said open recording region.

2. A falsification preventing apparatus according to claim 1, wherein
said falsification preventing apparatus further comprises an update recording region for updating the information stored in said open recording region; and
said copy means copies the information stored in said update recording region to said open recording region and said backup recording region when the information stored in said update recording region is updated.

3. A falsification preventing apparatus according to claim 2, further comprising:
authentication means for executing authentication of a user when the information stored in said update recording region is updated.

4. A falsification preventing method comprising the steps of:
detecting a write instruction with respect to an open recording region storing a page opened on the Internet; and
reading backup information on information stored in said open recording region from a backup recording region storing said backup information, and copying said backup information to said open recording region when the write instruction with respect to said open recording region is detected.

5. A falsification preventing method according to claim 4, further comprising the step of:
allowing the information in said open recording region and said backup recording region to be updated when the authentication of the user is executed.

6. A computer readable recording medium recording a program for making a computer execute:
a processing for detecting a write instruction with respect to an open recording region storing a page opened on the Internet; and
a processing for reading backup information on information stored in said open recording region from a backup recording region storing said backup information and copying said backup information to said open recording region when the write instruction with respect to said open recording region is detected.

7. A recording medium according to claim 6, wherein said program further makes the computer execute a processing for allowing the information in said open recording region and said backup recording region to be updated when authentication of user is executed.
